(19) United States
(12) Patent Application Publication
(10) Pub. No.: US 2026/0245220 A1
(43) Pub. Date: Aug. 20, 2026

(54) TRACKING METHOD, HEAD-MOUNTED DISPLAY DEVICE AND CAMERA TRACKER

(71) Applicant: HTC Corporation, Taoyuan City (TW)

(72) Inventors: Chun-Kai HUANG, Taoyuan City (TW); Chiao-Chien HUANG, Taoyuan City (TW)

(21) Appl. No.: 19/055,535

(22) Filed: Feb. 18, 2025

(51) Int. Cl. G06T 7/246; G06F 3/01; G06T 7/579

(52) U.S. Cl. CPC G06T 7/248; G06F 3/011; G06T 7/579; G06T 2207/30244

(57) ABSTRACT

A tracking method include following steps. In response to a tracking lost event occurring on a camera tracker, a tracker tracking data is transmitted from the camera tracker to a head-mounted display device. The tracker tracking data include a tracker current frame captured by the camera tracker. The head-mounted display device compares the tracker tracking data with keyframes stored in the head-mounted display device to identify a target keyframe similar to the tracker tracking data. A relocation prompt is generated according to a frame-wise difference between the tracker tracking data and the target keyframe. The relocation prompt is displayed on the head-mounted display device.

### BACKGROUND

### Field of Invention

The disclosure relates to a tracking method for an immersive system. More particularly, the disclosure relates to the tracking method involving a head-mounted display device and a camera tracker in the immersive system.

### Description of Related Art

In recent years, virtual reality has gained significant traction across various applications, from gaming and training simulations to remote operating systems. Despite advancements, a persistent challenge remains in providing users with a seamless and intuitive experience that effectively bridges the gap between physical and virtual worlds. Current systems often lack the ability to precisely track and interpret complex physical gestures, thus limiting the user's immersive experience and the efficiency of interactions within a virtual environment.

In order to provide an immersive experience to the user, it is required to track body movements of the user. In some cases, some body-mounted trackers may be worn on different body parts (e.g., wrists, ankles, waist) of the user, such that the body movements can be tracked based on these body-mounted trackers. Based on a tracking result of the body movements, the head-mounted display device can render the immersive content accordingly, so as to fulfill interactions between a virtual world and a real world.

### SUMMARY

The disclosure provides a tracking method include following steps. In response to a tracking lost event occurring on a camera tracker, a tracker tracking data is transmitted from the camera tracker to a head-mounted display device. The tracker tracking data include a tracker current frame captured by the camera tracker. The head-mounted display device compares the tracker tracking data with keyframes stored in the head-mounted display device to identify a target keyframe similar to the tracker tracking data. A relocation prompt is generated according to a frame-wise difference between the tracker tracking data and the target keyframe. The relocation prompt is displayed on the head-mounted display device.

The disclosure provides a head-mounted display device, which includes a camera, a storage unit, a transceiver circuit and a processor. The storage unit is configured to store a first mapdata. The first mapdata includes keyframes previously captured by the camera. The transceiver circuit is configured to receive a tracker tracking data from a camera tracker. The tracker tracking data includes a tracker current frame captured by the camera tracker. The processor is coupled with the storage unit, the camera and the transceiver circuit. The processor is configured to compare the tracker tracking data with the keyframes in the first mapdata to identify a target keyframe similar to the tracker tracking data, and the processor is configured to generate a relocation prompt according to a frame-wise difference between the tracker tracking data and the target keyframe. The displayer is coupled with the processor. The displayer is configured to display the relocation prompt.

The disclosure provides a camera tracker, which includes a camera, a transceiver circuit and a processor. The camera is configured to capture a tracker current frame. The processor is coupled with the camera and the transceiver circuit. The processor is configured to perform tracking based on the tracker current frame. In response to a tracking lost event, the processor is configured to generate a tracker tracking data comprising the tracker current frame, the transceiver circuit is configured to transmit the tracker current frame to a head-mounted display device.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an immersive system according to an embodiment of this disclosure.

FIG. 2 is a schematic diagram illustrating the head-mounted display device, a camera tracker located in a real environment according to an embodiment of this disclosure.

FIG. 3 is a flow chart of a tracking method according to some embodiments of the disclosure.

FIG. 4 is a schematic diagram illustrating an orientation difference between a tracker current frame of the tracker tracking data and a target keyframe selected from the keyframes in the mapdata according to some embodiments of the disclosure.

FIG. 5 is a schematic diagram illustrating a position difference between a tracker current frame of the tracker tracking data and a target keyframe selected from the keyframes in the mapdata according to some other embodiments of the disclosure.

FIG. 6 is a flow chart of a tracking method according to some embodiments of the disclosure.

FIG. 7 is a flow chart of a tracking method according to some embodiments of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

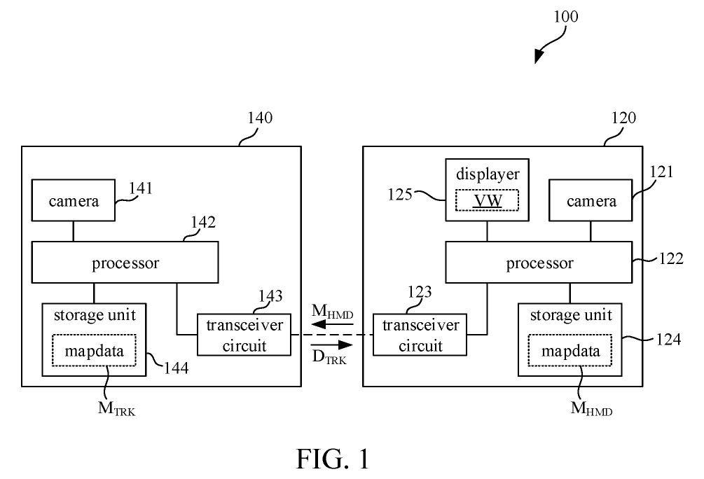

Reference is made to FIG. 1, which is a schematic diagram illustrating an immersive system 100 according to an embodiment of this disclosure. As shown in FIG. 1, the immersive system 100 includes a head-mounted display (HMD) device 120, a camera tracker 140. As shown in FIG. 1, the head-mounted display device 120 may include a camera 121, a processor 122, a transceiver circuit 123, a storage unit 124 and a displayer 125. The displayer 125 is configured to display a virtual environment VW to the user.

The camera 121 can be implemented by a CMOS image sensor, CCD image sensor, a depth camera or similar component. The processor 122 can be implemented by a central processing unit (CPU), a graphic processing unit (GPU), a tensor processing unit (TPU), an application-specific integrated circuit (ASIC) or similar component. The transceiver circuit 123 can be implemented by a WiFi transceiver circuit, a Bluetooth transceiver or similar component. The storage unit 124 can be implemented by a hard disk drive, a solid state drive, a flash drive, a random access memory or a read-only memory. The displayer 125 can be implemented by using high-resolution OLED or LCD panels, providing vibrant colors and wide viewing angles. It integrates with lenses to project immersive 3D visuals, ensuring a seamless virtual reality experience by adjusting focus and depth perception dynamically.

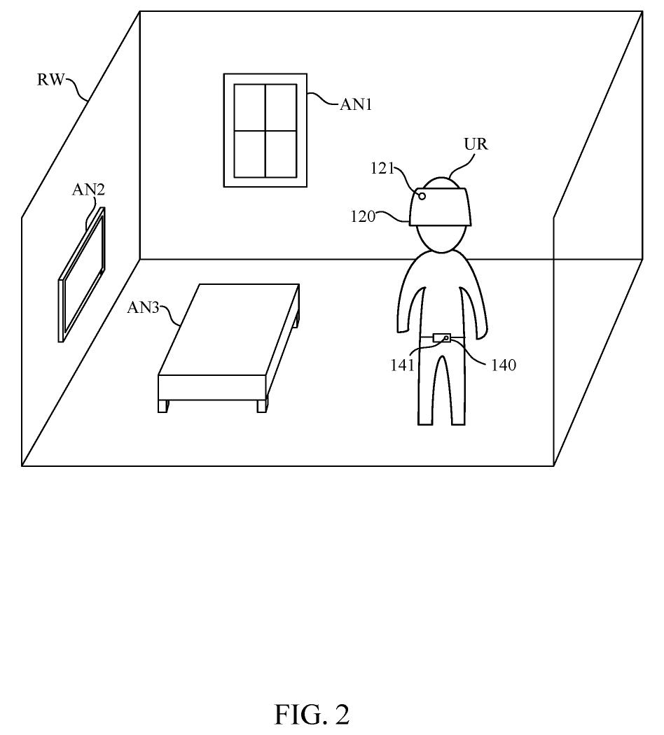

Reference is further made to FIG. 2, which is a schematic diagram illustrating the head-mounted display (HMD) device 120, a camera tracker 140 located in a real environment RW according to an embodiment of this disclosure.

In order to provide an immersive experience to the user UR, the immersive system 100 is configured to track a physical movement of the user, and provide an interaction between user’s physical movement and the virtual environment VW. In this case, the head-mounted display device 120 is mounted on the head of the user UR, such that a movement, a displacement, acceleration and/or a rotation of the head-mounted display device 120 can be detected and utilized to track a head movement of the user UR.

For example, the real environment RW as shown in FIG. 2 can be an indoor space (e.g., a bedroom or a conference room) in a real world, but the disclosure is not limited thereto. In some other embodiments, the real environment RW can also be a specific area at an outdoor space (not shown in figures). On the other hand, the head-mounted display device 120 is configured to display a virtual environment VW to the user UR.

As shown in FIG. 2, the head-mounted display device 120 can be worn on the head of the user UR. In some embodiments, the camera 121 of the head-mounted display device 120 can be configured to capture streaming images. The processor 122 is coupled with the camera 121, and the processor 122 is able to run a Simultaneous Localization and Mapping (SLAM) algorithm to track the head movement trajectory based on the streaming images.

In some embodiments, SLAM is a computational algorithm executed by the head-mounted display device 120 to build a map of an unknown environment while simultaneously determining its location within that map. SLAM is crucial for various applications, including virtual reality, augmented reality, and autonomous vehicles, robotics, where accurate mapping and localization are essential.

The camera 121 is configured to capture streaming images. Based on the streaming images, the processor 122 is configured to detect key features in the environment and create some keyframes, so as to establish a mapdata M_{HMD} about an environment around the head-mounted display device.

The processor 122 continuously estimates the current position and orientation (pose) of the head-mounted display device 120 by comparing the detected features in the latest camera images against those in previously captured frames. By determining how these features have shifted, the SLAM algorithm computes the movement of the head-mounted display device 120.

For example, the streaming images may cover an anchor item AN1 (e.g., a window), another anchor item AN2 (e.g., a television) and still another anchor item AN3 (e.g., a table) in the real environment RW as shown in FIG. 2. In most cases, positions of the anchor items AN1, AN2 and AN3 are fixed in the real environment RW. The SLAM algorithm executed by the processor 122 may keep tracking gap distances of the head-mounted display device 120 relative to the anchor items AN1, AN2 and AN3. Therefore, the processor 122 is capable of obtaining a position (and/or a rotation) of the head-mounted display device 120 relative to these anchor items AN1 to AN3. In this case, the processor 122 is able to track the head movement of the user UR.

As the user navigates the environment, the processor 122 executes SLAM to continually update the mapdata M_{HMD} with new information about the locations and features of the surroundings of the real world RW. Some frames captured by the camera 121 at significant points are selected as keyframes to maintain accurate mapping. Keyframes are selected images or data frames in the SLAM algorithm that capture significant and stable views of the environment, serving as crucial reference points. These keyframes created by the head-mounted display device 120 are added into the mapdata M_{HMD}. Keyframes contain vital visual features of the environment, enabling the system to recognize revisited areas. Keyframes act as stable anchors in the mapping process, helping reduce drift errors in tracking and localization, thereby enhancing overall accuracy.

The mapdata M_{HMD} is the output generated by the SLAM algorithm, representing the spatial layout or model of the environment (e.g., the real world RW). The mapdata M_{HMD} contains essential features (e.g., keyframes) of the environment, such as object locations, shapes, and spatial arrangements, which are crucial for understanding the surroundings. The mapdata M_{HMD} can stored in the storage unit 124. As the head-mounted display device 120 moves, mapdata M_{HMD} aids in continuous localization by updating the device’s position relative to the known map, ensuring accurate positional tracking.

The camera tracker 140 can be attached on a torso, a hand or a leg of the user UR. As shown in FIG. 2, the camera tracker 140 is worn on the waist of the user UR. However, the camera tracker 140 is not limited thereto. In some other embodiments, the immersive system 100 can include one or more camera tracker(s). The camera tracker(s) can be placed on wrists, thighs or ankles of the user UR.

In some embodiments, the camera tracker 140 may include a camera 141, a processor 142, a transceiver circuit 143 and a storage unit 144. Similar to aforementioned SLAM executed on the head-mounted display device 120, the camera 141 of the camera tracker 140 can be configured to capture streaming images. The processor 142 is coupled with the camera 141, and the processor 142 is able to run a Simultaneous Localization and Mapping (SLAM) algorithm to track a body movement (via the camera tracker 140) of the user UR.

Similar to the SLAM executed on the head-mounted display device 120 discussed above, the processor 142 also execute the SLAM algorithm, which continuously estimates the current position and orientation (pose) of the camera tracker 140 by comparing the detected features in the latest camera images against those in previously captured frames. By determining how these features have shifted, the SLAM algorithm computes the movement of the camera tracker 140.

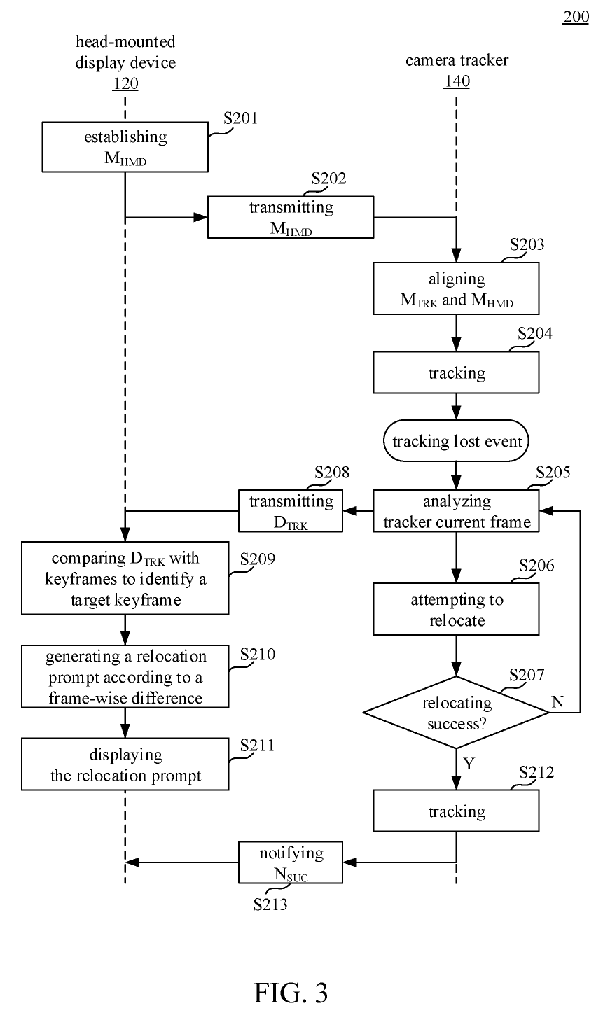

Reference is further made to FIG. 3, which is a flow chart of a tracking method 200 according to some embodiments of the disclosure. The tracking method 200 can be executed by the head-mounted display device 120 and the camera tracker 140 in aforesaid embodiments shown in FIG. 1 and FIG. 2.

As shown in FIG. 3, in step S201, the processor 122 of the head-mounted display device 120 runs the SLAM to establish the mapdata M_{HMD} about the environment around the head-mounted display device 120.

In order to detect overall movement of the user UR, the tracking results of the head-mounted display device 120 and the camera tracker 140 are required to be synchronized.

In step S202, the mapdata M_{HMD} is transmitted from the head-mounted display device 120 (via the transceiver circuit 123) to the camera tracker 140 (via the transceiver circuit 143). In step S203, the processor 142 of the camera tracker 140 is configured to align a mapdata M_{TRK} of the camera tracker 140 with the mapdata M_{HMD} from the head-mounted display device 120.

Aligning two SLAM devices (e.g., the head-mounted display device 120 and the camera tracker 140) can be acheived by sharing the mapdata M_{HMD} and integrating of their individual mapdata to be synchronized with common reference coordinates. In some embodiments, the alignment can be achieved by identifying common features or landmarks in the mapdata shared by both SLAM devices. This can be done using feature matching algorithms that detect and match similar visual features captured by both devices.

In some embodiments, the mapdata M_{HMD} may include some shared keyframes created by the head-mounted display device 120. These shared keyframes from the head-mounted display device 120 can be added into the mapdata M_{TRK} of the camera tracker 140. In addition to these shared keyframes, the mapdata M_{TRK} further include some unique keyframes created by the camera tracker 140.

In step S204, the camera 141 is configured to capture a tracker current frame, and the processor 142 is configured to perform tracking based on the tracker current frame in reference with the mapdata M_{TRK}.

In some embodiments, a tracking loss event may occur when the camera tracker 140 can no longer accurately determine the position and orientation (pose) of the camera tracker 140 relative to the map. For example, when the user UR performs quick or erratic movements, which may cause motion blur in camera images, making it challenging to detect and track features. Temporary obstacles or occlusions blocking the camera's view of tracked features may also lead to the tracking lost event.

The tracking loss event can disrupt the mapping and localization process, leading to errors in navigation or spatial awareness. How to recover from the tracking lost state is a key feature on the camera tracker 140.

In response to the tracking lost event occurring on the camera tracker 140, step S205 is executed by the processor 142 to analyze the tracker current frame by searching the mapdata M_{TRK} of the camera tracker 140 for keyframes similar to the tracker current frame. In some embodiments, the mapdata M_{TRK} includes some shared keyframes (created by the head-mounted display device 120) and some unique keyframes (created by the camera tracker 140). The processor 142 is configured to search the mapdata M_{TRK} for an approximate shared keyframe similar to the tracker current frame and an approximate unique keyframe similar to the tracker current frame.

Afterward, step S206 is executed by the processor 142 to attempt to relocate the camera tracker 140 according to the tracker current frame, the approximate shared keyframe and the approximate unique keyframe.

In this case, the approximate shared keyframe is established by the head-mounted display device 120 and transmitted to the camera tracker 140. The approximate unique keyframe is established by the camera tracker 140 itself. These approximate shared keyframe and the approximate unique keyframe may provide some hints or clues to relocate the camera tracker 140. The relocating can involve searching for a match between the tracker current frame with the approximate shared keyframe or the approximate unique keyframe.

Afterward, step S207 is executed by the processor 142 to check whether the relocating successes or not. If the relocating successes, the camera tracker 140 recovers from the tracking lost state, step S212 is executed to keep tracking. If the relocating fails, the tracking method 200 returns to step S205 for analyzing a next one of the tracker current frame.

In addition to aforesaid relocating steps, the camera tracker 140 may activate a user guidance function to guide the camera tracker 140 (or the head-mounted display device 120) back to a previous location with known visual features, so to help the camera tracker 140 re-establish its position.

As shown in FIG. 3, in response to the tracking lost event occurring on the camera tracker 140, step S208 is executed to transmit a tracker tracking data D_{TRK} from the camera tracker 140 to the head-mounted display device 120.

In some embodiments, the tracker tracking data D_{TRK} includes the tracker current frame captured by the camera 141 of the camera tracker 140.

In some other embodiments, the tracker tracking data D_{TRK} includes the tracker current frame, the approximate shared keyframe and also the approximate unique keyframe detected in step S205. In this case, the tracker tracking data D_{TRK} includes the tracker current frame and also two similar keyframes from the mapdata M_{TRK} stored in the camera tracker 140.

In step S209, the processor 122 of the head-mounted display device 120 is configured to compare the tracker tracking data D_{TRK} with all keyframes stored in the mapdata M_{HMD} of the head-mounted display device, in order to identify the target keyframe most similar to the tracker current frame. In some embodiments, during the comparison process, the processor 122 of the head-mounted display device (HMD) 120 infers the content of the tracker current frame to obtain an approximate pose of the camera tracker 140. This approximate pose facilitates finding an appropriate prompt in the subsequent step S210.

In some embodiments, all keyframes in the mapdata M_{HMD} are compared respectively with the tracker current frame in the tracker tracking data D_{TRK}, and the most similar keyframe in the mapdata M_{HMD} relative to the tracker current frame is selected as the target keyframe.

The target keyframe stored in the mapdata M_{HMD} is captured by the camera 121 at a previous location with known visual features. In other words, if the head-mounted display device 120 moves back to the previous location corresponding to the target keyframe, the camera tracker 140 (also mounted on the user UR) will be carried back to a similar position surrounded by the known visual features, it is helpful for the camera tracker 140 to recover the position-tracking.

In step S210, the processor 122 is configured to generate a relocation prompt according to a frame-wise difference between the tracker tracking data D_{TRK} (indicating a current position/orientation of the camera tracker 140) and the target keyframe (indicating a known position/orientation of the head-mounted display device 120). In step S211, the relocation prompt is displayed on the displayer 125 on the head-mounted display device 120, such that the relocation prompt can guide, hint or encourage the user to move back to a proper position/orientation to recover the tracking of the camera tracker 140.

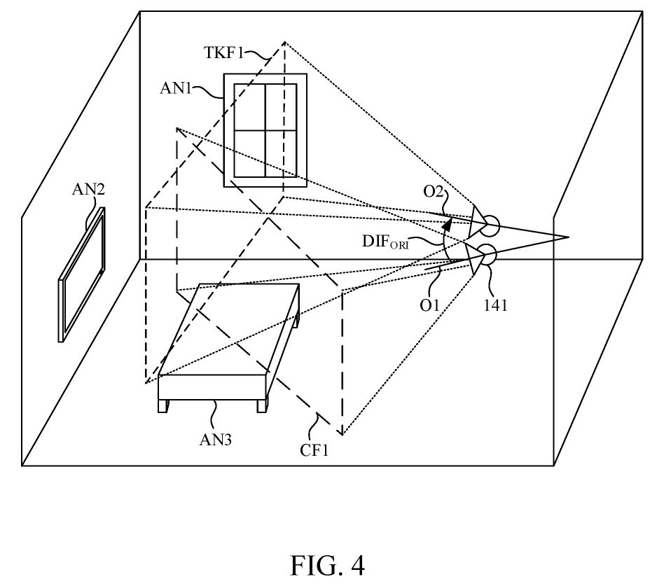

Reference is further made to FIG. 4, which is a schematic diagram illustrating an orientation difference DIF_{ORI}between a tracker current frame CF1 of the tracker tracking data D_{TRK}and a target keyframe TKF1 selected from the keyframes in the mapdata M_{HMD} according to some embodiments of the disclosure.

In some embodiments of step S210, the tracker current frame CF1 and the target keyframe TKF1 are analyzed to obtain the frame-wise difference. As the embodiments shown in FIG. 4, the tracker current frame CF1 is captured in view of the camera 141 along a first orientation O1. The target keyframe TKF1 is previously captured along a second orientation O2. In this case, the frame-wise difference between the tracker current frame CF1 and the target keyframe TKF1 is an orientation difference DIF_{ORI} while capturing these two frames.

In response to the orientation difference DIF_{ORI} exceeding an orientation threshold (e.g., 30 degrees), the relocation prompt is generated to guide a user to rotate according to the orientation difference DIF_{ORI}. As shown in FIG. 4, the second orientation O2 is located on the right side of the first orientation O1 at a 45-degree angle. In this case, the relocation prompt can be an instruction displayed on the displayer 125 to guide the user UR to rotate rightward by 45-degree angle. The relocation prompt can include texts or figures(e.g., a curved arrow to the right side) displayed on the displayer 125.

According to hints of the relocation prompt, the user UR may rotate the body toward to the second orientation O2. After the rotation, the camera tracker 140 attached on the user’s body can face a proper field of view, which include more visual features of the environment. In this case, the camera 141 on the camera tracker 140 may capture a following tracker current frame, which is trackable to the SLAM algorithm.

After the camera tracker 140 recovers the tracking function (referring to steps S207 and S212 in FIG. 3), step S213 is executed to transmit a track-recovery notification N_{SUC} from the camera tracker 140 to the head-mounted display device 120. When the head-mounted display device 120 receives the track-recovery notification N_{SUC}, the head-mounted display device 120 may stop displaying the relocation prompt on the displayer 125.

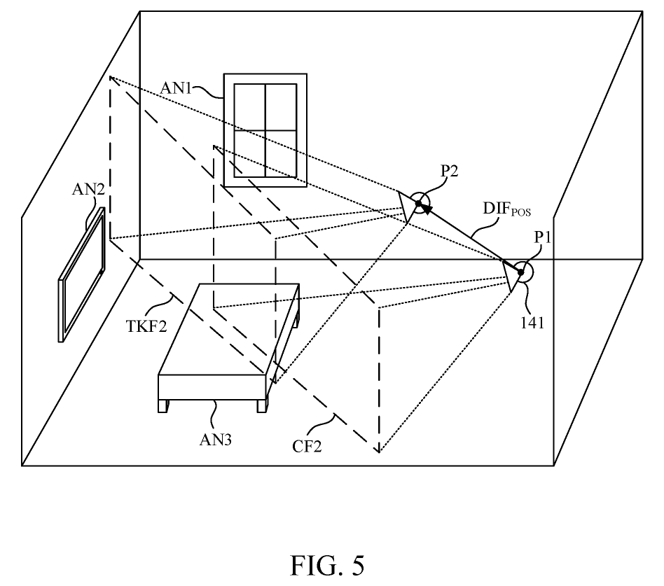

Reference is further made to FIG. 5, which is a schematic diagram illustrating a position difference DIF_{POS} between a tracker current frame CF2 of the tracker tracking data D_{TRK} and a target keyframe TKF2 selected from the keyframes in the mapdata M_{HMD} according to some other embodiments of the disclosure. FIG. 5 illustrates another example different from FIG. 4. In FIG. 5, it is assumed that the target keyframe TKF2 and the tracker current frame CF2 face similar orientations and captured at different positions.

In some embodiments of step S210, the tracker current frame CF2 and the target keyframe TKF2 are analyzed to obtain the frame-wise difference. As the embodiments shown in FIG. 5, the tracker current frame CF2 is captured in view of the camera 141 at a first position P1. The target keyframe TKF2 is previously captured at a second position P2. In this case, the frame-wise difference between the tracker current frame CF2 and the target keyframe TKF2 is a position difference DIF_{POS} while capturing these two frames.

In response to the position difference DIF_{POS} exceeding a position threshold (e.g., 0.5 meter), the relocation prompt is generated to guide a user to move according to the position difference DIF_{POS}. As shown in FIG. 5, the second position P2 is located at the front right relative the first position P1. In this case, the relocation prompt can be an instruction displayed on the displayer 125 to guide the user UR to move from the first position P1 toward the second position P2. The relocation prompt can include texts or figures(e.g., footprints toward the front right) displayed on the displayer 125.

According to hints of the relocation prompt, the user UR may move toward to the second position O2. After moving to the second position P2, the camera tracker 140 attached on the user’s body can face a proper field of view, which include more visual features of the environment. In this case, the camera 141 on the camera tracker 140 may capture a following tracker current frame, which is trackable to the SLAM algorithm.

After the camera tracker 140 recovers the tracking function (referring to steps S207 and S212 in FIG. 3), step S213 is executed to transmit a track-recovery notification N_{SUC} from the camera tracker 140 to the head-mounted display device 120. When the head-mounted display device 120 receives the track-recovery notification N_{SUC}, the head-mounted display device 120 may stop displaying the relocation prompt on the displayer 125.

As discussed in embodiments shown in FIG. 4 and FIG. 5, the relocation prompt can be generated according to the orientation difference DIF_{ORI} or the position difference DIF_{POS}. However, the disclosure is not limited thereto.

In other embodiments, the relocation prompt can be generated according to a combination of the orientation difference DIF_{ORI} and the position difference DIF_{POS} between the tracker current frame and the target keyframe. For example, the relocation prompt (e.g., a curved arrow and footprints) can guide the user UR to rotate to a specific orientation and also to move toward a specific position.

In aforesaid embodiments shown in FIG. 4 and FIG. 5, the orientation difference DIF_{ORI} and the position difference DIF_{POS} are detected between the tracker current frame and the target keyframe. In some other embodiments, the orientation difference DIF_{ORI} and the position difference DIF_{POS} can also be detected by comparing the approximate shared keyframe or the approximate unique keyframe (transmitted along with the tracker current frame in the tracker tracking data D_{TRK}) with the target keyframe.

Based aforesaid embodiments, the tracking method 200 shown in FIG. 3 can generate the relocation prompt. The relocation prompt displayed on the displayer 125 of the head-mounted display device 120 may guide the user UR to move toward a proper orientation/position, such that the camera tracker 140 has a better chance to relocate and recover the tracking function.

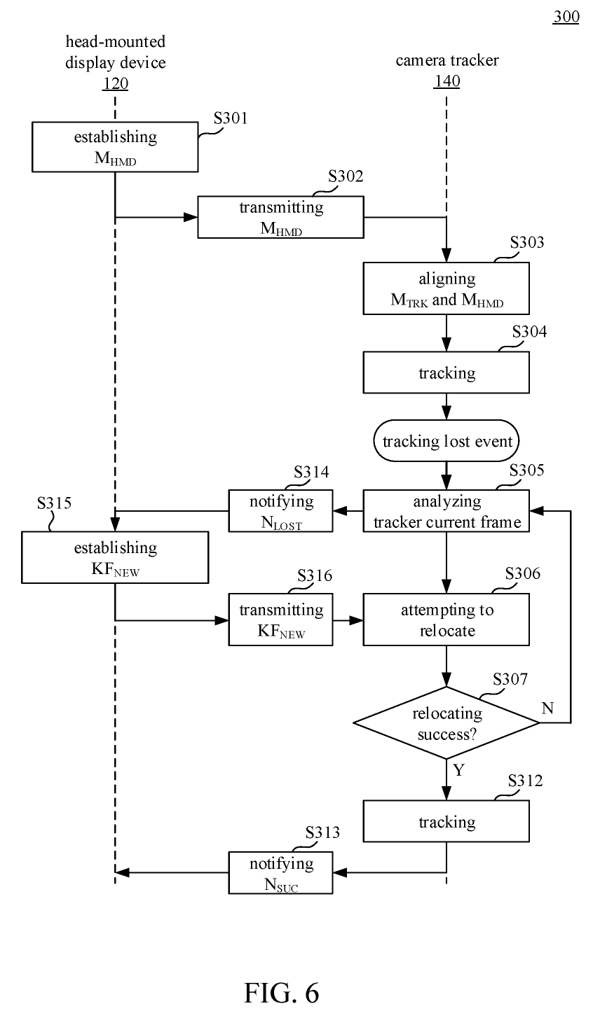

However, the disclosure is not limited to generate the relocation prompt. In some other embodiments, in response to the tracking lost event, the head-mounted display device 120 is able to generate a new keyframe, so as to help the camera tracker 140 to relocate itself. Reference is further made to FIG. 6, which is a flow chart of a tracking method 300 according to some embodiments of the disclosure. The tracking method 300 can be executed by the head-mounted display device 120 and the camera tracker 140 in aforesaid embodiments shown in FIG. 1 and FIG. 2. Steps S301, S302, S303, S304, S305, S306, S307, S312 and S313 in the tracking method 300 in FIG. 6 are similar to aforementioned steps S201, S202, S203, S204, S205, S206, S207, S212 and S213 in the tracking method 200 in FIG. 3, and not repeated again.

As shown in FIG. 6, in response to tracking lost event occurring on the camera tracker 140, step S314 is executed to transmit a tracking lost notification N_{LOST} from the camera tracker 140 (by the transceiver circuit 143) to the head-mounted display device 120 (via the transceiver circuit 123). Once the head-mounted display device 120 receives the tracking lost notification N_{LOST}, the head-mounted display device 120 is triggered by the tracking lost notification N_{LOST.} In this case, step S315 is executed to shoot a current captured image by the camera 121 and the processor 122 is configured to establish a new keyframe KF_{NEW} based the current captured image by the camera 121.

In some embodiments, because the head-mounted display device 120 equips with more computational resource (e.g., the processor 122 can handle more complex computations than the processor 142) or better image-sensing capacity (e.g., the camera 121 has a higher resolution than the camera 141 or a wider field of view), the new keyframe KF_{NEW} established by the head-mounted display device 120 may cover meaningful visual features beneficial for tracking.

Step S316 is executed to transmit the new keyframe KF_{NEW} from the head-mounted display device 120 (through the transceiver circuit 123) to the camera tracker 140 (via the transceiver circuit 143). In some embodiments, the camera tracker 140 is configured to align the mapdata M_{TRK} of the camera tracker 140 with the new keyframe KF_{NEW} received from the head-mounted display device 120. In this embodiments, while the processor 142 attempting to relocate, the processor 142 may perform the SLAM algorithm based on the tracker current frame in reference with the new keyframe KF_{NEW} and the mapdata M_{TRK}. The new keyframe KF_{NEW} may provide extra hints or clues to relocate the camera tracker 140 in addition to the mapdata M_{TRK}.

Based aforesaid embodiments, the tracking method 300 shown in FIG. 6 can activate the head-mounted display device 120 to generate the new keyframe KF_{NEW}. The new keyframe KF_{NEW} can be provided to the camera tracker 140, such that the camera tracker 140 has a better chance to relocate and recover the tracking function. In some embodiments, the tracking method 300 shown in FIG. 6 can be executed by the immersive system 100 in parallel with the tracking method 200 shown in FIG. 3.

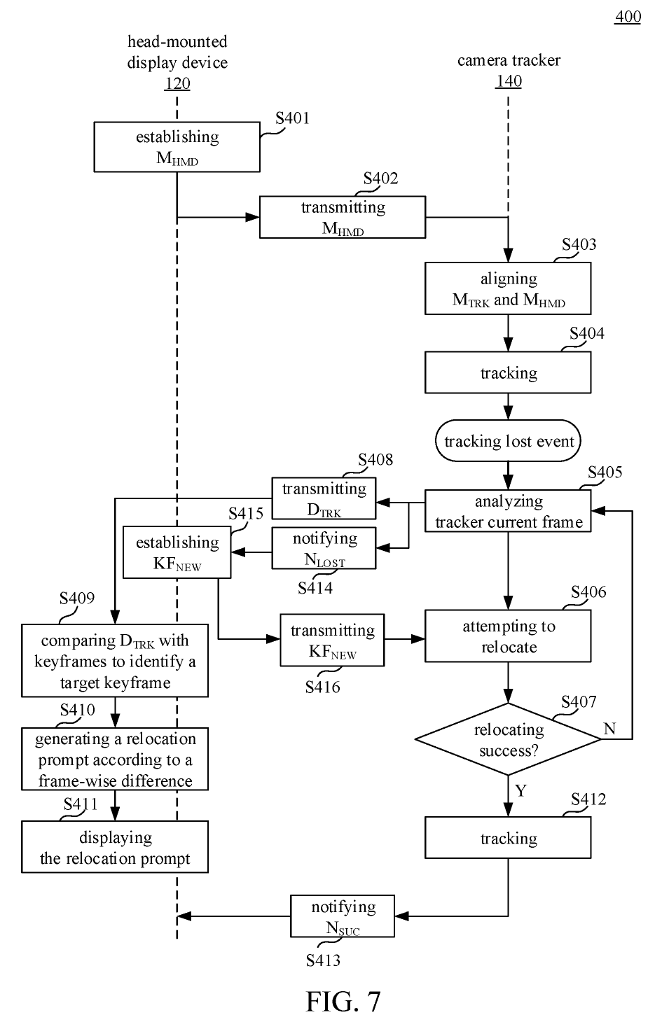

In some embodiments, generating of the relocation prompt and generating the new keyframe KF_{NEW} for relocation can be executed in parallel between the head-mounted display device 120 and the camera tracker 140. Reference is further made to FIG. 7, which is a flow chart of a tracking method 400 according to some embodiments of the disclosure. The tracking method 400 can be executed by the head-mounted display device 120 and the camera tracker 140 in aforesaid embodiments shown in FIG. 1 and FIG. 2. Steps S401, S402, S403, S404, S405, S406, S407, S408, S409, S410, S411, S412 and S413 in the tracking method 400 of FIG. 7 are similar to aforementioned steps S201, S202, S203, S204, S205, S206, S207, S208, S209, S210, S211, S212 and S213 in the tracking method 200 in FIG. 3, and not repeated again. Steps S414, S415 and S416 in the tracking method 400 of FIG. 7 are similar to aforementioned steps S314, S315 and S316 in the tracking method 300 in FIG. 6, and not repeated again.

As shown in FIG. 7, in response to the tracking lost event occurring on the camera tracker 140, steps S414, S415 and S416 are executed to transmit a tracking lost notification NLOST to the head-mounted display device 120 for establishing a new keyframe KFNEW based the current captured image by the camera 121. The new keyframe KFNEW is transmitted back to the camera tracker 140 for relocating. In addition, in response to the tracking lost event occurring on the camera tracker 140, steps S408, S409, S410 and S410 for generating a relocation prompt according to the frame-wise difference between the tracker tracking data DTRK (indicating a current position/orientation of the camera tracker 140) and the target keyframe (indicating a known position/orientation of the head-mounted display device 120). These two mechanisms are able to execute an automatic relocation and also provide relocation prompts in response to the tracking lost event.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A tracking method, comprising:
in response to a tracking lost event occurring on a camera tracker, transmitting a tracker tracking data from the camera tracker to a head-mounted display device, wherein the tracker tracking data comprises a tracker current frame captured by the camera tracker;
comparing, by the head-mounted display device, the tracker tracking data with keyframes stored in the head-mounted display device to identify a target keyframe similar to the tracker tracking data;
generating a relocation prompt according to a frame-wise difference between the tracker tracking data and the target keyframe; and
displaying the relocation prompt on the head-mounted display device.

2. The tracking method of claim 1, wherein generating the relocation prompt comprising:
obtaining an orientation difference between the tracker tracking data and the target keyframe; and
in response to the orientation difference exceeding an orientation threshold, generating the relocation prompt to guide a user to rotate according to the orientation difference.

3. The tracking method of claim 1, wherein generating the relocation prompt comprising:
obtaining a position difference between the tracker tracking data and the target keyframe; and
in response to the position difference exceeding a position threshold, generating the relocation prompt to guide a user to move according to the position difference.

4. The tracking method of claim 1, further comprising:
in response to the tracking lost event occurring on the camera tracker, transmitting a tracking lost notification from the camera tracker to the head-mounted display device;
in response to the tracking lost notification, establishing a new keyframe by the head-mounted display device;
transmitting the new keyframe from the head-mounted display device to the camera tracker; and
relocating the camera tracker based on the new keyframe.

5. The tracking method of claim 1, further comprising:
running a Simultaneous Localization and Mapping algorithm on the head-mounted display device to establish a first mapdata about an environment around the head-mounted display device;
transmitting the first mapdata from the head-mounted display device to the camera tracker;
aligning a second mapdata of the camera tracker with the first mapdata.

6. The tracking method of claim 1, further comprising:
in response to the tracking lost event occurring on the camera tracker, searching a second mapdata of the camera tracker for an approximate shared keyframe similar to the tracker current frame and an approximate unique keyframe similar to the tracker current frame; and
attempting to relocate the camera tracker according to the tracker current frame, the approximate shared keyframe and the approximate unique keyframe,
wherein the approximate shared keyframe is established by the head-mounted display device and transmitted to the camera tracker, the approximate unique keyframe is established by the camera tracker.

7. The tracking method of claim 6, wherein the tracker tracking data transmitted from the camera tracker to the head-mounted display device further comprises the approximate shared keyframe and the approximate unique keyframe.

8. A head-mounted display device, comprising:
a camera;
a storage unit, configured to store a first mapdata, the first mapdata comprising a plurality of keyframes previously captured by the camera;
a transceiver circuit, configured to receive a tracker tracking data from a camera tracker, wherein the tracker tracking data comprises a tracker current frame captured by the camera tracker;
a processor, coupled with the storage unit, the camera and the transceiver circuit, wherein the processor is configured to compare the tracker tracking data with the keyframes in the first mapdata to identify a target keyframe similar to the tracker tracking data, and the processor is configured to generate a relocation prompt according to a frame-wise difference between the tracker tracking data and the target keyframe; and
a displayer, coupled with the processor, the displayer being configured to display the relocation prompt.

9. The head-mounted display device of claim 8, wherein the processor is configured to obtain an orientation difference between the tracker tracking data and the target keyframe,
in response to the orientation difference exceeding an orientation threshold, the processor is configured to generate the relocation prompt to guide a user to rotate according to the orientation difference.

10. The head-mounted display device of claim 8, wherein the processor is configured to obtain a position difference between the tracker tracking data and the target keyframe,
in response to the position difference exceeding a position threshold, the processor is configured to generate the relocation prompt to guide a user to move according to the position difference.

11. The head-mounted display device of claim 8, wherein the transceiver circuit is configured to receive a tracking lost notification from the camera tracker,
in response to the tracking lost notification, the processor is configured to establish a new keyframe, and the transceiver circuit is configured to transmit the new keyframe to the camera tracker.

12. The head-mounted display device of claim 8, wherein the processor is configured to run a Simultaneous Localization and Mapping algorithm to establish the first mapdata about an environment around the head-mounted display device, the transceiver circuit is configured to transmit the first mapdata from the head-mounted display device to the camera tracker.

13. A camera tracker, comprising:
a camera, configured to capture a tracker current frame;
a transceiver circuit; and
a processor, coupled with the camera and the transceiver circuit, wherein the processor is configured to perform tracking based on the tracker current frame,
in response to a tracking lost event, the processor is configured to generate a tracker tracking data comprising the tracker current frame, the transceiver circuit is configured to transmit the tracker current frame to a head-mounted display device.

14. The camera tracker of claim 13, wherein in response to the tracking lost event, the transceiver circuit is configured to transmit a tracking lost notification from the camera tracker to the head-mounted display device, the tracking lost notification is configured to trigger the head-mounted display device for establishing a new keyframe.

15. The camera tracker of claim 14, wherein the transceiver circuit is configured to receive the new keyframe from the head-mounted display device, the processor is configured to relocate the camera tracker based on the new keyframe.

16. The camera tracker of claim 13, wherein the transceiver circuit is configured to receive a first mapdata from the head-mounted display device about an environment around the head-mounted display device,
the processor is configured to run a Simultaneous Localization and Mapping algorithm to establish a second mapdata, and the processor is further configured to align the second mapdata with the first mapdata.

17. The camera tracker of claim 13, wherein,
in response to the tracking lost event, the processor is configured to search a second mapdata stored in the camera tracker for an approximate shared keyframe similar to the tracker current frame and an approximate unique keyframe similar to the tracker current frame,
the processor is configured to relocate the camera tracker according to the tracker current frame, the approximate shared keyframe and the approximate unique keyframe,
wherein the approximate shared keyframe is established by the head-mounted display device and transmitted to the camera tracker, the approximate unique keyframe is established by the camera tracker.

18. The camera tracker of claim 17, wherein the tracker tracking data transmitted from the camera tracker to the head-mounted display device further comprises the approximate shared keyframe and the approximate unique keyframe.

19. The camera tracker of claim 13, wherein the camera tracker is mounted on a body part of a user.

20. The camera tracker of claim 13, wherein the processor is configured to run a simultaneous localization and mapping algorithm to track a body movement of a user.
